(19) United States
(12) Patent Application Publication
(10) Pub. No.: US 2008/0152763 A1
(43) Pub. Date: Jun. 26, 2008

(54) FOOD PRODUCTS HAVING CAFFEINE INCORPORATED THEREIN

(76) Inventor: Robert Bohannon, Chapel Hill, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/961,656

(22) Filed: Dec. 20, 2007

Related U.S. Application Data
(60) Provisional application No. 60/871,359, filed on Dec. 21, 2006.

(51) Int. Cl. A23L 1/30; A21D 2/00; A21D 2/08; A21D 13/00; A23G 3/54

(52) U.S. Cl. 426/94; 426/629; 426/620; 426/658; 426/549; 426/573; 426/519; 426/281; 426/275

(57) ABSTRACT

The invention provides food products having additives useful for providing a desired effect, such a stimulating effect. In one embodiment, the invention is directed to a food product having an additive amount of caffeine incorporated therein. In specific embodiments, the food product is a doughnut, a bagel, or a breakfast bar.

### CROSS-REFERENCE TO RELATED APPLICATIONS

The present application claims priority to U.S. Provisional Patent Application Ser. No. 60/871,359, filed Dec. 21, 2006, which is incorporated herein by reference.

### FIELD OF THE INVENTION

The invention relates to food products having specific additives. More specifically, the invention relates to food products having a content of caffeine incorporated therein.

### BACKGROUND

Caffeine is a xanthine alkaloid that acts as a stimulant in humans and is naturally found in the leaves and beans of coffee. It is a central nervous system (CNS) stimulant, having the effect of temporarily warding off drowsiness and restoring alertness. While caffeine is naturally found in beverages, such as coffee and tea, it is added to other beverages, such as soft drinks, which have been popular for many years, and energy drinks, which have recently become quite popular.

The world's primary source of caffeine is the coffee bean, and the caffeine content in coffee varies widely depending on the bean type and the method of preparation used. In general one serving of coffee ranges from about 40 milligrams of caffeine for a single shot (30 milliliters) of Arabica-variety espresso to about 80-125 milligrams of caffeine for a cup of drip coffee. Tea is another common source of caffeine, usually containing about half as much caffeine per serving as coffee (i.e., 30-75 mg per cup), depending on the strength of the brew. Certain types of tea, such as black and oolong, contain somewhat more caffeine than most other teas. Chocolate derived from cocoa contains a small amount of caffeine. Soft drinks typically contain about 35 to 60 milligrams of caffeine per 12 ounce serving. By contrast, caffeine pills, such as NO-DOZ®, contain 100-200 milligrams of caffeine per dose.

Today, global consumption of caffeine has been estimated at 120,000 tons per annum, making it the world's most popular psychoactive substance. This number equates to one serving of a caffeinated beverage for every person, per day.

While it is clear that many people have a great affinity for caffeinated beverages, not all people may choose a presently available source. For example, many individuals may desire the stimulating effect of a morning coffee, but not all individuals seeking such an effect enjoy the taste of coffee. Thus, there exists a void in the art for food products that provide caffeine in more desirable forms.

Perhaps arising from the common association of doughnuts as breakfast foods, it is not surprising that doughnuts (as well as other pastries) are often consumed with coffee. While coffee has recently been elevated to a trendy, social status in association with coffee houses, such as STARBUCK'S® and CARIBOU COFFEE®, coffee has historically been a morning drink, likely arising from its stimulating effect. More particularly, while doughnuts are extremely popular breakfast items, not all morning doughnut consumers are also coffee consumers. Similarly, not everyone seeking a “pick-me-up”, whether it be to overcome morning sleepiness or ward off a “mid-afternoon slump”, chooses to obtain the stimulating effect of caffeine through consumption of a caffeinated beverage.

Doughnuts are particularly popular breakfast foods (especially in the United States) as they are generally compact, easily transported, and an all-around convenient option in a fast-paced world. Other types of pastries are also very popular, not only as breakfast foods but also as desserts and snack foods. For example, pies, cinnamon rolls, cupcakes and other similar items have had commercial success under brand names, such as HOSTESS® and LITTLE DEBBIE®. Still further, bagels and various breakfast bars are also popular food items associated with morning meals.

As pointed out, not all individuals seeking the stimulating effects of caffeine choose to receive the caffeine from beverages, such as coffee, or from over-the-counter pills. Rather, consumers desire to obtain their caffeine from more pleasurable activities, such as eating food items. Thus, there remains a need for consumer products providing the desired stimulating effect of caffeine without being limited to caffeinated beverages.

### SUMMARY OF THE INVENTION

The present invention provides food products having additives useful for providing particular effects, such as a stimulating effect. In a particular aspect, the present invention is directed to food products having caffeine incorporated therein. Preferably, the caffeine is not naturally occurring in the food product but is rather included in the food product as an additive.

In one embodiment, the invention is directed to an edible food product. Preferably, the food product is provided as a single serving (such as a single doughnut, a single bagel, or a single breakfast bar) and comprises a caffeine-containing additive. In specific embodiments, the additive comprises microencapsulated caffeine particles. Such particles can have a range of characteristics. For example, the particles can be formed using a specific coating material, such as a coating material that is safe for human consumption and that renders the caffeine tasteless. In one embodiment, the coating material comprises a stearate compound. In other embodiments, the particles can have a specific content of caffeine. For example, the particles can comprise about 10% to about 90% by weight caffeine. The microencapsulated caffeine particles can also be of a particular size, such as being of a size of less than about 0.7 mm. The single serving of the food product preferably includes the caffeine in a specific amount. For example, in one embodiment, the additive is present in a content sufficient so that the single serving of the food product includes about 1 mg to about 400 mg of caffeine.

The caffeine additive can be included in the food product in a variety of ways. In one embodiment, the caffeine additive can be added directly to the food product prior to cooking, baking, or frying the food product. In other embodiments, the caffeine additive can be included in materials that are added to the food product after cooking, baking, or frying. For example, the food product can comprise a topping or a filling material, and the caffeine-containing additive can be present in the topping or filling material. Such topping or filling materials can include, for example, icing, glazing, powders, jellies, jams, custards, and combinations thereof. In certain embodiments, the food product of the invention is a topping or filling material that can be a stand-alone product or be an additive to another food product (e.g., a doughnut glaze or icing).

In one specific embodiment, the invention is directed to a caffeine-containing doughnut. For example, the doughnut can comprise microencapsulated caffeine particles comprising a coating material that is safe for human consumption and renders the encapsulated caffeine tasteless. The microencapsulated caffeine can particularly comprise about 10% to about 90% by weight caffeine and have a particle size of less than about 0.7 mm. In specific embodiments, the microencapsulated caffeine can be present in a content sufficient so that doughnut includes about 10 mg to about 200 mg of caffeine. In certain embodiments, the microencapsulated caffeine is added to a topping of filling material used with the doughnut. In another embodiment, the invention is directed to a caffeine-containing bagel. In yet another embodiment, the invention is directed to a caffeine-containing breakfast bar.

In another aspect, the food product of the invention can be a powdered material. For example, in one embodiment, the food product comprises a diluent or bulking agent, such as maltodextrin, and further comprises microencapsulated caffeine particles, as described herein. In specific embodiments, the powdered food product can include further component, such as a sweetener or further diluent or bulking agent.

In other embodiments, the powdered food product includes substantially only a diluent or bulking agent and the microencapsulated caffeine as described herein. For example the food product can consist essentially of maltodextrin and microencapsulated caffeine particles that are formed of about 10% to about 90% by weight caffeine and a coating material that is safe for human consumption and renders the encapsulated caffeine tasteless.

In another aspect, the present invention also provides processes for preparing food products. In one embodiment, the invention provides a process for preparing a food product that comprises adding to the food product a predetermined amount of microencapsulated caffeine particles as described herein. In certain embodiments, the process can comprise adding the microencapsulated caffeine particles to the food product prior to performing a cooking, baking, or frying step. In other embodiments, the process can comprise adding the microencapsulated caffeine particles to the food product after performing a cooking, baking, or frying step, such as a component of a topping or filling material that is added to the food product. For example, the microencapsulated caffeine particles can be included in a glaze or icing added to a doughnut. In other embodiments, the invention can be directed to processes wherein the microencapsulated caffeine particles are incorporated into a raw material that is commonly used in preparing a food product (such as a dry baking blend used for preparing doughnuts).

The invention also includes processes for dosing a food product with a predetermined amount of caffeine. For example, in one embodiment, the process comprises providing a raw material for use in preparing the food product, the raw material comprising microencapsulated caffeine particles such that a known mass or volume of said component comprises a predetermined amount of caffeine. The process further comprises preparing the food product using the raw material with the microencapsulated caffeine particles to provide the food product having an amount of caffeine within a predetermined concentration range.

In yet another aspect, the present invention provides a microencapsulated caffeine product. The microencapsulated caffeine is particularly beneficial in that it combines a variety of physical properties making the microencapsulated caffeine useful in food products without imparting an undesirable bitter taste. The unique microencapsulated caffeine particles are also capable of being present in a food product without disrupting or lessening the favorable organoleptic properties of the food product.

### DETAILED DESCRIPTION OF THE INVENTION

The present inventions now will be described more fully hereinafter with reference to specific embodiments of the invention provided herewith. Indeed, the invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

In North America, it is estimated that 90% of adults consume some amount of caffeine daily. Coffee is one of the most recognized sources of caffeine. While people enjoy the effects of caffeine, though, not everyone likes coffee or chooses to drink coffee whenever the stimulating effect of caffeine is desired. Some people rather turn to soft drinks, teas, or even energy drinks as a source of caffeine. The present invention provides an alternative source of caffeine that is particularly associated with foods consumed at times when people generally seek the stimulating effects of caffeine. This is accomplished according to the invention by the provision of caffeine in a form that allows for incorporation into food product while effectively masking the bitter taste of the caffeine. In certain embodiments, the caffeine is microencapsulated. Preferably, the microencapsulated caffeine is in a form that provides a specific caffeine content, has a specific particle size range, and uses a coating material that is safe for human consumption, renders the encapsulated caffeine tasteless and, optionally, provides thermostability in a specific temperature range. In specific embodiments, the invention provides breakfast food items having caffeine directly incorporated therein. In other embodiments, the invention provides snack products having caffeine directly incorporated therein. In particular, the invention provides pastry products having caffeine directly incorporated therein.

Generally, the invention is directed to food products having additives useful for providing a desired effect. Specific reference may be made herein to pastry products, which encompasses any type of food product commonly made from ingredients, such as flour, butter, shortening, baking powder, eggs, and sugar. While “pastry” is often used specifically in reference to pies, tarts, and quiches, the term “pastry product”, is used in a broader sense herein, and encompasses a variety of baked or fried foods that are generally sweetened and used as breakfast, dessert, or snack foods. Of course, reference to pastry products is not meant to limit the scope of the invention. Rather, the invention encompasses a wide variety of food products, particularly food products that are baked goods or fried goods. Specific, non-limiting examples of food products encompassed by the invention include doughnuts, rolls, cakes, muffins, cookies, pies, brownies, breads, bagels, toaster pastries, and biscuits. Still further examples of food products that are encompassed by the invention include a variety of pre-formed, bar-shaped food products that are generally encompassed by the term “breakfast bar”. Such breakfast bars include cereal bars, pastry bars, fiber bars, protein bars, and other, similar products.

For purposes of simplicity, the invention may be described throughout in reference to the specific embodiment of a doughnut. However, description made in reference to doughnuts is not limited to such a specific embodiment and should not be viewed as limiting the scope of the disclosure. Rather, discussion of inclusion of caffeine in doughnuts or any other specific food product equally applies to all food products encompassed by the present invention.

Pastry products are made and sold daily throughout the world. In fact, in many parts of the world, pastry products make up a significant percentage of the daily caloric intake of the population. However, it has not been heretofore recognized that pastry products, or the other various food products described herein, could be used as a vehicle for providing various additives useful for providing particular effects. In one specific embodiment, the invention realizes the ability to include caffeine in food products, particularly pastry products, and more particularly doughnuts, bagels, and breakfast bars. However, the invention is not limited to simply caffeine. Rather, the invention visualizes the ability to include a multitude of further additives, including, but not limited to, vitamins, minerals, herbs, weight-loss supplements, energy-promoting supplements, and various further dietary supplements that may be useful for providing a particular health benefit or perceived benefit. The invention is particularly described in reference to incorporation of caffeine into food products. Of course, the invention is not so limited, and the disclosure in terms of incorporation of caffeine fully encompasses incorporation of the further additives noted above, as well as further additives that would be recognizable by the skilled artisan having the benefit of the present disclosure.

In one embodiment, the invention provides a food product comprising an additive. Preferably, the additive comprises caffeine. The concentration of the caffeine present in the food product can vary depending upon the size of the food product and the desired stimulating effect of the food product. Moreover, the caffeine concentration can vary depending upon the method of incorporation of the caffeine into the food product, as further discussed below.

One specific example of a food product according to the present invention incorporating caffeine is doughnuts. Doughnuts are deeply rooted in American culture with regional variations being found worldwide. A doughnut (or donut) is generally understood to be a sweet, deep-fried (or baked) piece of dough or batter. The two most common types of doughnuts are the torus-shaped ring doughnut, and the filled doughnut, a flattened sphere injected with jam/jelly, cream, custard, or another sweet filling. Doughnuts are usually fried, but in rare cases the dough is squeezed into a ball and rested between the rims of an electric cooker.

Doughnuts can be classified as raised doughnuts, made using a yeast-based dough, or cake doughnuts, made using a special type of cake batter. Raised doughnuts typically contain about 25% oil by weight, whereas the oil content of cake doughnuts is generally around 20%, but cake doughnuts often have extra fat included in the batter before frying. Cake doughnuts are fried for about 90 seconds, turning once, at between 190° C. and 198° C. Yeast-raised doughnuts absorb more oil because they take longer to fry, about 150 seconds, at 182° C. to 190° C. Cake doughnuts typically weigh between 24 g and 28 g, whereas yeast-raised doughnuts average 38 g.

After being fried, ring doughnuts are often topped with a glaze, icing, or a powder such as cinnamon or sugar. Ringless doughnuts, such as fritters and jelly doughnuts, may be glazed and/or injected with jam or custard. There are many other specialized doughnut shapes such as bear claws, “old-fashioneds”, bars (a rectangular shape), and twists (where the dough is twisted around itself before cooking). In the Northeast USA, bars and twists are often referred to as crullers. Doughnut holes are small spheres that are made out of the dough taken from the center of ring doughnuts or made to look as if they are.

Bagels are another specific example of a food product that can incorporate caffeine according to the invention. A bagel is generally recognized as a hard bread roll made of yeast dough that is twisted into a small doughnutlike shape, cooked in simmering water, and then baked. Bagels have become a popular breakfast food and are available in a wide variety of flavors.

Yet another specific example of a food product that can incorporate caffeine according to the invention are breakfast bars. Breakfast bars have more recently gained popularity as a “healthier” alternative to candy bars. They are typically marketed to health conscious consumers as fiber bars, protein bars, fruit and nut bars, and cereal bars.

In specific embodiments, the food product of the invention is described as being an edible food product. As thus used, the word “edible” refers to food products that are eaten. As such, the term edible does not include drinkable products. Thus, an edible food product according to the invention would exclude typical caffeinated drinks, such as coffee, tea, soft drinks, and energy drinks. Rather, an edible food product according to the invention is a typical food product that is eaten by biting and/or chewing the food product prior to ingestion (or swallowing). Thus, an edible food product of the invention can particularly be any food product that typically requires mastication in association with ingestion.

Generally, the food product of the invention comprises up to about 400 mg of caffeine per serving. One serving is typically an entire single product (e.g., a whole doughnut, a whole bagel, or a whole breakfast bar). Of course, a “bite-size” or mini food product (such as a doughnut hole) would be expected to have a lower concentration of caffeine than a full-size serving. In certain embodiments, the food products of the invention include from about 1 mg to about 400 mg of caffeine, about 2 mg to about 350 mg of caffeine, about 5 mg to about 300 mg of caffeine, about 10 mg to about 250 mg caffeine, about 10 mg to about 200 mg caffeine, about 10 mg to about 150 mg caffeine, about 10 mg to about 100 mg of caffeine, or about 10 mg to about 50 mg of caffeine per serving.

The food product of the present invention can be described as being provided as a single serving. Such description generally refers to an entire single product, as noted above. Thus, the food product of the invention typically comprises a single doughnut, a single bagel, a single breakfast bar, or any other food item provided as a single serving. However, the term “single serving” should not be confused with the number of servings. For example, it is common in the food industry for a single unitary product to be provided and the nutrition information be described in terms of a serving size that is less than the full mass or volume of the single unitary product. By use of the term “single serving”, the present invention intends to refer to the single unitary product, and any description of the product in terms of nutritional information per serving size would not depart from the invention. Moreover, it is envisioned that a number of single servings of the inventive food product could be packaged together for product distribution or sale, and such bulk packing of the food product would also be encompassed by the invention. For example, a box of doughnuts (e.g., 12 doughnuts) would still be viewed as providing a food product as a single serving (i.e., 12 single doughnuts), and the mere bulk packaging of the single unitary products would not depart from the scope of the present invention.

Caffeine has a bitter taste that, while an accepted component of the taste of drinks like coffee and tea, is undesirable in foods typically associated with a sweet flavor, such as doughnuts or other pastries, or food items typically associated with a neutral flavor (e.g., bagels) or a spiced flavor (e.g., breakfast bars). Thus, it is desirable for caffeine incorporated in food products to be essentially tasteless (or at least have the bitter taste masked). Further, caffeine is only slightly soluble in water (about 22 mg/mL at 25° C.). It is thus difficult to get a suitable amount of caffeine into a pastry product to have a stimulating effect while avoiding an undesirable taste. Accordingly, the present invention is not a matter of simple addition of a compound to a product. Rather, there are formidable hurdles to be overcome that have not been solved in the art.

In one embodiment of the invention, a food product is provided with an additive comprising caffeine and at least one further component useful for increasing the solubility of the caffeine and/or at least partially masking the taste of the caffeine. Any solubilizer capable of increasing the solubility of caffeine in preparations (such as doughs and batters) useful in preparing food products could be used according to the invention. Of course, preferable solubilizers are both non-toxic in amounts suitable to effective according to the invention and do not impart undesirable taste to the end product.

In one embodiment, useful solubilizers include surfactants, such as polyethylene oxide/polypropylene oxide surfactants, polyglycerols, and lecithins. In further embodiments, the solubilizers can include other food ingredients. For example, sodium benzoate and sodium saccharine can each be used as a caffeine solubilizer.

In one embodiment, caffeine is provided as an additive comprising a solution of caffeine and one or more solubilizers. For example, the additive can comprise an aqueous solution of caffeine and sodium benzoate. In certain embodiments, the solution can comprise up to about 25% (w/v) caffeine, up to about 20% (w/v) caffeine, up to about 15% (w/v) caffeine, or up to about 12.5% (w/v) caffeine. Preferably, the solution comprises 0.01% to about 15% (w/v), about 0.1 to about 12.5% (w/v), or about 1 to about 10% (w/v) of caffeine.

The concentration of the solubilizer can vary depending upon the nature of the solubilizer and the desired end content of caffeine. In certain embodiments, the solution can be present in a concentration equal to or less than the concentration of the caffeine. In one embodiment, the caffeine and the solubilizer are present in about a 1:1 weight ratio. For example, a solution comprising 10% caffeine and 10% sodium benzoate in water (w/w/v) can be used. In another example, the solution comprises 5% caffeine and 5% sodium saccharine in water (w/w/v).

In addition to solubilizers, the additive included in the inventive food product can comprise other components in combination with the caffeine. For example, the additive can comprise natural or artificial sweeteners, spices, essential oils, and other types of taste maskers known to useful in foods, such as compounds capable of blocking bitter taste receptors.

In further embodiments, it is beneficial for the caffeine to be incorporated into the food product in the form of a pre-formed component that is coated or microencapsulated. Coating or microencapsulation can be useful to delay release of the caffeine until after the pastry product has been ingested (i.e., is past the point of stimulating the bitter taste receptors in the mouth).

Any type of coating or encapsulating material useful in preparing components for use in food products can be used according to the invention. Accordingly, the coating material can comprise any material that is a food grade material or is otherwise generally safe for human consumption. Suitable coatings include mono- and di-glycerides, as well as polymeric materials, such as ethylcellulose (EC), methylcellulose, hydroxypropylcellulose (HPC), hydroxypropylmethylcellulose (HPMC), lipids and oils (such as vegetable, seed, or nut oils) and the like. Commercial coating products sold under the names EUDRAGIT® and DESCOTE® are specific examples of coatings and encapsulations useful according to the invention.

In specific embodiments, the coating material used to prepare microencapsulated caffeine comprises a compound that is known under the designation “Generally Recognized As Safe”, or GRAS. The designation GRAS was established by the U.S. Food and Drug Administration (FDA) to encompass chemicals that are safe to be added to foods. GRAS compounds are exempted from the usual Federal Food, Drug, and Cosmetic Act (FFDCA) food additive tolerance requirements. Accordingly, any material that is on the GRAS list and that could used as a coating material in a microencapsulation process could be used in the microencapsulated caffeine that is incorporated into the food products of the present invention.

The coating material used in forming the microencapsulated caffeine is also preferably useful for masking the bitterness typically associated with caffeine. In certain embodiments, the coating material is a material that renders the encapsulated caffeine tasteless. In other embodiments, the coating material is a material that is itself substantially or completely tasteless. Thus, the coating material can be described as a material that substantially or completely masks or blocks the bitter taste of caffeine.

Many food products that can encompass caffeine additives according to the invention are subject to high temperature preparation (e.g., baking or frying). Thus, it is beneficial for the microencapsulated caffeine to be formed with a coating material that is thermostable, preferably meaning it can withstand the high temperatures of food preparation (i.e., in the range of 100° C. to 200° C.) without melting, degrading, or otherwise exposing the contents of the microcapsule. In certain embodiments, the coating material comprises a material that is thermostable up to a temperature of at least about 80° C., at least about 90° C., at least about 100° C., at least about 110° C., or at least about 120° C. The thermostability of the material can also be a function of time. Accordingly, the coating materials of the invention can include materials that are thermostable up to even greater temperatures when only exposed to the temperature for a relatively short time. For example, a coating material useful according to the invention can be thermostable up to a temperature of about 200° C. for a time of at least about 10 minutes, at least about 5 minutes, or at least about 3 minutes.

According to a preferred embodiment, the coating material used to prepare microencapsulated caffeine comprises a salt or ester of stearic acid (i.e., stearates). Preferred embodiments are metal salts of stearic acid, such as zinc stearate and calcium stearate. The use of stearates as microencapsulation coating materials is particularly useful in light of the increased melting temperature afforded by these products. Zinc stearate, for example, has a melting point of about 120-130° C. Accordingly, stearates are stable at cooking temperatures (particularly for short times), and the encapsulated caffeine is not released by the cooking process.

Microencapsulation is generally recognized as a process by which small particles or droplets of a material are surrounded by a coating to produce capsules known as microcapsules, which can actually include capsules having sizes in the nanometer to millimeter range. The material inside the capsule is refereed to as the core, internal phase or fill, whereas the wall is sometimes called a shell, coating, or membrane. As described above, the shell, coating, or membrane can comprise any material that is thermostable, tasteless (or effective to render the encapsulated caffeine tasteless), and generally safe for human consumption (particularly on the GRAS list).

Particle size is preferably adjustable such that a product prepared therewith can exhibit a mildly grainy effect (which may be desirable in some applications) to practically no noticeability of the presence of the microparticles. In specific embodiments, the microencapsulated caffeine is of a sufficient small particle size such that the presence of the microcapsules is not recognizable to the average human consumer. Coated or microencapsulated particles useful according to the present invention are preferably suitable for incorporation into raw dough or batter and unaffected by cooking, as well as capable of incorporation into a topping material, such as icing, glazing, or powder, or a filling material (e.g., jelly/jam or custard). Thus, the food product of the invention can comprise a topping or filling material that includes microencapsulated caffeine.

In certain embodiments, the microparticles are sized such that a maximum percentage is no larger than a specified size. Generally, the microparticles are spherical in shape, although it is not required. In taste testing performed by the present inventor, it was determined that microparticles of a sufficiently small size in order to arrive at a food product having desirable organoleptic properties. Particularly, particles over a specific size range were found to lead to a food product that was “gritty” in texture, which is generally undesirable. It was thus determined that microencapsulated caffeine for use in the present invention should be of a particular size that would avoid the “gritty” sensation, provide favorable texture qualities, and still sufficiently mask the bitter taste of the caffeine.

Typically, the microparticles are sized to be generally less than about 1 mm in size, preferably less than about 0.8 mm, less than about 0.7 mm, less than about 0.6 mm, less than about 0.5 mm, less than about 0.4 mm, less than about 0.3 mm, less than about 0.2 mm, or less than about 0.1 mm. In further embodiments, the microparticles can be less than about 50 μm, less than about 40 μm, less than about 30 μm, less than about 20 μm, less than about 10 μm, or less than about 1 μm. In certain embodiments, the microparticles have sizes in the range of about 0.2 mm to about 2 mm, about 0.3 mm to about 1.5 mm, about 0.4 mm to about 1 mm, or about 0.5 mm to about 1 mm. In a specific embodiment, the microparticles are sized such that at least 98% of the microparticles are less than 0.6 mm in size. In other embodiments, the microparticles are sized such that less than or equal to 2% of the microparticles are retained on a 30 mesh screen. In still further embodiments, microparticles are of a size making the particles essentially or completely undetectable by a consumer of a product incorporating such particles. In such embodiments, the microparticles can have average sizes in the range of about 1 μm to about 0.8 mm, about 10 μm to about 0.7 mm, about 0.1 mm to about 0.7 mm, about 0.2 mm to about 0.7 mm, or about 0.3 mm to about 0.6 mm. In on specific embodiment, the microparticles have an average size of 0.4 mm to about 0.8 mm or about 0.6 mm.

Microparticles can vary in relation to the overall content of the encapsulated material. Preferably, microparticles used according to the present invention comprise predominately the encapsulated material; however lesser contents can be acceptable. In certain embodiments, the microparticles comprise about 10% by weight caffeine, based on the overall weight of the microparticles, about 20% by weight caffeine, about 30% by weight caffeine, about 40% by weight caffeine, about 50% by weight caffeine, about 55% by weight caffeine, about 60% by weight caffeine, about 65% by weight caffeine, about 70% by weight caffeine, about 80% by weight caffeine, or about 90% by weight caffeine based on the overall weight of the microparticles. In a specific embodiment, the microparticles comprise about 10% to about 90% by weight caffeine, about 20% to about 80% by weight caffeine, about 30% to about 70% by weight caffeine, about 30% to about 60% by weight caffeine, or about 40% to about 60% by weight caffeine.

In certain embodiments, the microencapsulated caffeine used in the present invention consists essentially of the caffeine and the coating material. In further embodiments, the microencapsulated can comprise the caffeine and the coating material and optional further components. In particular, the microencapsulated caffeine can comprise further component useful to mask the bitter taste of the caffeine, such as sweeteners, solubilizers, or the like. The microencapsulated caffeine can further comprise components useful to facilitate the microencapsulation of the caffeine.

The microencapsulated caffeine used in the food product of the present can be prepared according to a variety of methods so long as the microencapsulated caffeine exhibits the various properties described herein. In particular, the microencapsulated caffeine should exhibit one or more of the following: have an average particle size within the ranges described herein; provide the caffeine in a specific weight percentage, as described herein; use a coating material effective to mask the bitter taste of caffeine (and preferably be essentially tasteless itself); use a coating material that is generally recognized as safe for human consumption; and use a coating material that exhibits a desired degree of thermostability, as otherwise described herein. Any microencapsulation method capable of preparing microencapsulated caffeine having these desired properties could be used, and a skilled person would be capable of recognizing an appropriate method.

For example, microencapsulated caffeine according to the invention could be formed using any of various chemical encapsulation techniques such as solvent evaporation, solvent extraction, organic phase separation, interfacial polymerization, simple and complex coacervation, in-situ polymerization, liposome encapsulation, and nanoencapsulation. Alternatively, physical methods of encapsulation could be used, such as spray coating, pan coating, fluid bed coating, annular jet coating, spinning disk atomization, spray cooling, spray drying, spray chilling, stationary nozzle coextrusion, centrifugal head coextrusion, or submerged nozzle coextrusion. Microcapsules are commercially available, and exemplary types of microcapsule technologies are of the type set forth in Gutcho, Microcapsules and Microencapsulation Techniques (1976); Gutcho, Microcapsules and Other Capsules Advances Since 1975 (1979); and Kondo, Microcapsule Processing and Technology (1979), all of which are incorporated herein by reference.

In addition to the above, several companies presently provide services in the field of microencapsulation and would be expected to be capable of preparing microencapsulated caffeine to meet the physical parameters described herein. For example, Maxx Performance, Inc. (Chester, N.Y.), Watson, Inc. (West Haven Conn.), Southwest Research Institute (San Antonio, Tex.), and GAT Food Essentials, GmbH (Ebenfurth, Austria) are examples of companies specializing in microencapsulation technologies, particularly for use in the food industry. A skilled person, armed with the present disclosure, would be expected to be capable of preparing microencapsulated caffeine for use in the present invention by using manufacturing methods provided by such companies.

While the food product of the invention can comprise microencapsulated caffeine as an additive, in certain embodiments, the food product can substantially comprise the microencapsulated caffeine itself. For example, the food product of the invention can comprise microencapsulated caffeine blended with one or more diluents or bulking agents, preferably in a powdered form. In these embodiments, the food item can itself be an additive that a user can apply as desired to a non-caffeinated food item.

Food additives are well recognized as “packets” of specific additives. For example, it is common for natural and artificial sweeteners to be provided in packets that represent a specific serving of the additive. Likewise, the microencapsulated caffeine of the present invention can be combined with a food-grade diluent or bulking agent and be packaged in individual packets. Thus, a consumer has available individual packets of a caffeinated food product that can be added to a non-caffeinated food product as desired.

In one embodiment, the food product of the invention comprises microencapsulated caffeine, as described herein, in combination with maltodextrin. Preferably, the maltodextrin is in a powdered form such that the microencapsulated caffeine readily blends with the maltodextrin to form a substantially uniform product.

The microencapsulated caffeine can be combined with the maltodextrin in a variety of ratios. For example, the microencapsulated caffeine can be combined with the maltodextrin such that a specific mass or volume of the combined product provides a specific content of caffeine. In specific embodiments, the maltodextrin and microencapsulated caffeine are combined and portioned such that a single serving of the combined product provides an amount of caffeine as previously described herein.

In other embodiments, the product is defined in a straight mass/mass ratio. For example, in specific embodiments, the microencapsulated caffeine and the maltodextrin are combined in a mass/mass ratio of about 1/99 to about 50/50, about 2/98 to about 40/60, about 3/97 to about 20/80, or about 4/96 to about 10/90 (total microparticle mass/maltodextrin mass). In other embodiments, the mass/mass ration is about, about 3/97 to about 10/90, about 4/96 to about 8/92, or about 5/95 to about 7/93. Of course, such ratios would also extend to other diluents or bulking agents used in the food product according to this embodiment of the invention. It is also understood that the weight percent of caffeine in the given microparticles can be varied so that a specific microparticle mass can provide a specific amount of caffeine in the caffeine/maltodextrin food product.

The microencapsulated caffeine used according to this aspect of the invention can have the physical characteristics as otherwise described herein. In certain embodiments, the microencapsulated caffeine comprises a sufficient percentage of caffeine so that the product of microencapsulated caffeine and maltodextrin provides a specific content of caffeine per teaspoon of product. For example, in specific embodiments, the product provides about 5 mg to about 200 mg caffeine per tsp, about 10 mg to about 150 mg caffeine per tsp, about 20 mg to about 100 mg caffeine per tsp, or about 25 mg to about 75 mg caffeine per tsp. In one embodiment, the product provides about 50 mg caffeine per tsp.

Of course, as previously noted, this embodiment of the invention is not specifically limited to combination of microencapsulated caffeine with maltodextrin. Rather, other diluents or bulking agents could be used. For example, the bulking agent could include any food grade product generally available in a powdered form. In specific embodiments, the diluent or bulking agent comprises a sweet taste-imparting substance. For example, the diluent or bulking agent could comprise table sugar (sucrose) or an artificial sweetener (e.g., saccharin, aspartame, or sucralose).

The present invention also provides methods of preparing food products incorporating additives, such as caffeine. In one embodiment, the invention is directed to a process of preparing a food product comprising adding to the food product a predetermined amount of caffeine. The caffeine can be added as a lone component. Preferably, the caffeine is a component of an additive that may comprise one or more further components, as described above.

The caffeine additive can be included in the food product prior to or after cooking or baking of the food product. For example, in one embodiment, where the food product comprises a doughnut, the caffeine additive is incorporated into the dough or batter prior to cooking the doughnuts. In another embodiment, the caffeine additive is incorporated into a glaze, icing, or powder used to coat the doughnut after cooking or a filler material used to fill the doughnut after cooking. Such methods can clearly be recognized as extending to other food products. For example, microencapsulated caffeine, as described herein, could be included in any raw food product mixture prior to cooking or baking of the food product (e.g., prior to baking a bagel or baking a breakfast bar).

In certain embodiments, the caffeine additive can be provided in bulk components. For example, in certain doughnut processes, the dry ingredients for the doughnut dough or batter are provided as a pre-mixed dry component. A measured amount of the pre-mixed dry component is added to the fat and liquid components to prepare the dough or batter. In such cases, the pre-mixed dry component could be provided with the caffeine additive included therein (e.g., as a caffeinated dry mix versus a non-caffeinated dry mix). Alternately, the caffeine additive could be provided as a stand-alone product that is added to the dough or batter in a measured amount. Similarly, the caffeine additive could be provided pre-mixed with a glazing, icing, powder, or filler mixture. Alternately, the stand-alone caffeine additive could be added to the glazing, icing, powder, or filler mixture at the time of preparation. In cases where the caffeine additive is pre-mixed, it may be useful to include preservatives or stabilizers to maintain shelf-life of the pre-mixed component.

Still further, the invention provides a process for dosing a food product with a predetermined amount of caffeine. In one embodiment, the process comprises providing caffeine in a component for use in preparing a food product such that a known mass or volume of said component comprises a predetermined amount of caffeine. The component can then be used in preparing the food product so as to provide a food product having an amount of caffeine within a predetermined concentration range, such as described herein. As previously noted, the caffeine can be a stand-alone product such that a known mass or volume of the product is known to contain a predetermine concentration of caffeine. Likewise, the caffeine can be in a pre-mixed component such that a known mass or volume of the pre-mix is known to contain a predetermined concentration of caffeine. This is particularly useful to avoid overdosing of the caffeine and to be able to equate the caffeine content of a serving of the food product to other known caffeinated items. For example, a single doughnut could be dosed to incorporate a concentration of caffeine equivalent to the concentration of caffeine found in an average cup of coffee.

In another aspect, the invention generally provides microencapsulated caffeine particles that are formed, sized, and dosed for incorporation into a food product without adversely affecting the organoleptic properties of the food product. It has been discovered, according to the present invention, that microencapsulate caffeine microparticles having a combination of properties as described herein can be included in food product without adversely affecting the organoleptic properties of the food product. This has not heretofore been possible because of the failure to recognize the exact properties that must be established to achieve non-perceptive inclusion into the food product. Specifically, the microencapsulated caffeine must have a specific particle size in order to avoid a “gritty” texture that is generally undesirable in food products, particularly icings, glazings, and other food products that typically have a “smooth” texture. Moreover, the microencapsulated caffeine must have a specific coating to avoid the bitter taste of caffeine and be safe for human consumption. Still further, the microparticles must include a certain percentage of caffeine to be effectively incorporated into a food in a small enough dose to be economical and avoid adversely affecting the texture of the food product. Only the present invention has recognized the crossroads of these many concerns and achieved a microencapsulated caffeine particle having the specific properties useful to be incorporated into a variety of food items without adversely affecting the organoleptic properties of the food product. The ability to achieve this end is illustrated in the appended examples.

### EXAMPLES

The following examples are provided to illustrate specific embodiments of the invention and are not to be construed as limiting the scope of the invention. Rather, various further embodiments, modifications, and equivalents thereof are encompassed by the present invention.

### Example 1

### Preparation of Caffeine/Sodium Benzoate Solution

A solution was prepared by dissolving powdered caffeine and powdered sodium benzoate in water to achieve a final concentration of 10% by weight caffeine and 10% by weight sodium benzoate, based on the total volume of the solution. The solution was clear and stable and had a bitter taste. The bitter taste was essentially eliminated by diluting to a range of 0.01% to 0.1% by weight of caffeine based on the overall volume of the solution (i.e., 1-10 mg of caffeine per mL of solution).

### Example 2

### Preparation of Pastry Product Incorporating Caffeine Into Icing

A frosted doughnut was prepared using microencapsulated caffeine particles containing 40% or 50% (+/−2%) by weight caffeine. The microencapsulated caffeine particles had a particle size such that a maximum of 2% of the microparticles were retained on a 30 mesh sieve (i.e., an average particle size of approximately 0.6 mm). The microencapsulated caffeine used a food grade lipid coating material rendering the overall microparticle essentially tasteless. The microencapsulated caffeine was prepared via a manufacturing process at Maxx Performance, Inc. that was carried out to meet the requested microparticle characteristics.

The microencapsulated caffeine was mixed with pre-made cake frosting in an amount of 1 gram of microencapsulated particles per 100 grams of frosting. The frosting with the microencapsulated caffeine incorporated therein was used to frost a doughnut at an application rate of 10 grams of frosting per doughnut (an effective dose of 50 mg caffeine per doughnut). In a blind taste test, people were asked to taste the doughnut with the frosting applied thereto. All respondents indicated there was no perceptible bitter taste. Likewise, all respondents indicated the texture of the frosted doughnut was acceptable (i.e., not overly “gritty”). While doughnuts including 40% by weight caffeine microparticles or 50% by weight caffeine microparticles were both acceptable in taste, the doughnuts include the 40% by weight caffeine microparticles were scored better on overall taste.

### Example 3

### Caffeinated Breakfast Bar

A caffeinated breakfast bar was prepared by making a dry mix and a separate liquid mixture. The dry mix contained all dry ingredients for the breakfast bar (e.g., oats, rice cereal, dried fruits, nuts, and seeds)—approximately 6 cups total. The dry mix further included approximately ½ tsp of microencapsulated caffeine (approximately 40% by weight caffeine). The liquid mixture included all liquid components used as binder, sweeteners, and other flavorants (e.g., honey, fruit juice, and spices).

The liquid mixture components were heated to a low boil to form a homogeneous liquid and cooled to about 120° F. The still warm liquid mixture was combined with the dry mixture and stirred. The combined dry and liquid mixtures were divided into 12 even servings and baked at around 350° F. for approximately 30 minutes.

### Example 4

### Caffeinated Food Additive

A caffeinated food additive was prepared by combining maltodextrin 93.4% by weight) with microencapsulated caffeine (6.6% by weight). The microencapsulated caffeine comprised approximately 40% by weight caffeine. The powder product was in a form suitable for adding to other food products (i.e., cereal), and a single serving of the product (e.g., approximately 1 tsp) provided approximately 50 mg caffeine.

Many modifications and other embodiments of the inventions set forth herein will come to mind to one skilled in the art to which these inventions pertain having the benefit of the teachings presented in the foregoing descriptions. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An edible food product provided as a single serving and comprising a caffeine-containing additive, the additive comprising microencapsulated caffeine particles comprising about 10% to about 90% by weight caffeine and a coating material that is safe for human consumption and renders the encapsulated caffeine tasteless, the microencapsulated caffeine particles having a size of less than about 0.7 mm and being present in a content sufficient so that the single serving of the food product includes about 1 mg to about 400 mg of caffeine.

2. The food product of claim 1, wherein the food product is selected from the group consisting of doughnuts, bagels, and breakfast bars.

3. The food product of claim 2, wherein the food product comprises a topping or a filling material, and wherein the caffeine-containing additive is present in the topping or filling material.

4. The food product of claim 3, wherein the topping or filling material is selected from the group consisting of icing, glazing, powders, jellies, jams, custards, and combinations thereof.

5. The food product of claim 1, wherein the microencapsulate caffeine particles comprise a stearate coating.

6. The food product of claim 1, wherein the microencapsulated caffeine particles comprise a zinc stearate coating.

7. The food product of claim 1, wherein the microencapsulated caffeine particles comprise a calcium stearate coating.

8. The food product of claim 1, wherein the microencapsulated caffeine particles comprise about 30% to about 60% by weight caffeine.

9. The food product of claim 1, wherein the microencapsulated caffeine particles have a size of less than about 0.6 mm.

10. The food product of claim 1, wherein the microencapsulated caffeine particles have a size of less than about 0.5 mm.

11. The food product of claim 1, wherein the microencapsulated caffeine particles have a size of less than about 0.4 mm.

12. The food product of claim 1, wherein the microencapsulated caffeine particles have a size of less than about 0.3 mm.

13. The food product of claim 1, wherein the microencapsulated caffeine particles are present in a content sufficient so that the single serving of the food product includes about 10 mg to about 200 mg of caffeine.

14. The food product of claim 1, wherein the microencapsulated caffeine particles are present in a content sufficient so that the single serving of the food product includes about 10 mg to about 100 mg of caffeine.

15. The food product of claim 1, wherein the coating material is thermostable up to a temperature of at least about 100° C.

16. A doughnut comprising microencapsulated caffeine particles comprising about 10% to about 90% by weight caffeine and a coating material that is safe for human consumption and renders the encapsulated caffeine tasteless, the microencapsulated caffeine particles having a size of less than about 0.7 mm and being present in a content sufficient so that doughnut includes about 10 mg to about 200 mg of caffeine.

17. The doughnut of claim 16, wherein the doughnut further comprises a topping or a filling material, and wherein the microencapsulated caffeine particles are present in the topping or filling material.

18. The doughnut of claim 17, wherein the topping or filling material is selected from the group consisting of icing, glazing, powders, jellies, jams, custards, and combinations thereof.

19. The doughnut of claim 16, wherein the coating material is selected from the group consisting of zinc stearate, calcium stearate, and combinations thereof.

20. A bagel comprising microencapsulated caffeine particles comprising about 10% to about 90% by weight caffeine and a coating material that is safe for human consumption and renders the encapsulated caffeine tasteless, the microencapsulated caffeine particles having a size of less than about 0.7 mm and being present in a content sufficient so that the bagel includes about 10 mg to about 200 mg of caffeine.

21. A food product comprising maltodextrin and microencapsulated caffeine particles comprising about 10% to about 90% by weight caffeine and a coating material that is safe for human consumption and renders the encapsulated caffeine tasteless, the microencapsulated caffeine particles having a size of less than about 0.7 mm, wherein the food product is in a powdered form.

22. A food product consisting essentially of maltodextrin and microencapsulated caffeine particles that are formed of about 10% to about 90% by weight caffeine and a coating material that is safe for human consumption and renders the encapsulated caffeine tasteless, the microencapsulated caffeine particles having a size of less than about 0.7 mm, wherein the food product is in a powdered form.

23. A process for preparing a food product comprising adding to the food product a predetermined amount of microencapsulated caffeine particles comprising about 10% to about 90% by weight caffeine and a coating material that is safe for human consumption and renders the encapsulated caffeine tasteless, the microencapsulated caffeine particles having a size of less than about 0.7 mm.

24. The process of claim 23, comprising adding the microencapsulated caffeine particles to the food product prior to performing a cooking, baking, or frying step.

25. The process of claim 23, comprising adding the microencapsulated caffeine particles to the food product after performing a cooking, baking, or frying step.

26. The process of claim 23, comprising adding the microencapsulated caffeine particles to the food product as a component of a topping or filling material.

27. The process of claim 26, wherein the topping or filling material is selected from the group consisting of icing, glazing, powders, jellies, jams, custards, and combinations thereof.

28. The process of claim 23, wherein the food product is selected from the group consisting of doughnuts, bagels, and breakfast bars.

29. A process for preparing a food product comprising preparing the food product using a raw material that is dosed with microencapsulated caffeine particles.

30. The process of claim 29, wherein the microencapsulated caffeine particles comprise about 10% to about 90% by weight caffeine and a coating material that is safe for human consumption and renders the encapsulated caffeine tasteless.

31. The process of claim 29, wherein the microencapsulated caffeine particles have a size of less than about 0.7 mm.

32. The process of claim 29, wherein the microencapsulated caffeine particles are thermostable up to a temperature of at least about 100° C.

33. A process for dosing a food product with a predetermined amount of caffeine, comprising:
providing a raw material for use in preparing the food product, the raw material comprising microencapsulated caffeine particles such that a known mass or volume of said component comprises a predetermined amount of caffeine; and
preparing the food product with the raw material including the microencapsulated caffeine particles to provide the food product having an amount of caffeine within a predetermined concentration range.

34. The process of claim 33, wherein the food product is selected from the group consisting of doughnuts, bagels, and breakfast bars.

35. The process of claim 33, wherein the microencapsulated caffeine particles comprise a stearate coating and about 10% to about 90% by weight caffeine.

36. The process of claim 33, wherein the microencapsulated caffeine particles have a size of less than about 0.7 mm.
